(19) United States
(12) Patent Application Publication
(10) Pub. No.: US 2017/0166713 A1
(43) Pub. Date: Jun. 15, 2017

(54) THERMOPLASTIC COMPOSITIONS

(71) Applicant: LANXESS DEUTSCHLAND GMBH, Köln (DE)

(72) Inventors: Tobias BENIGHAUS, Muenster (DE); Detlev JOACHIMI, Krefeld (DE); Guenter MARGRAF, Dormagen (DE)

(21) Appl. No.: 15/119,501

(22) PCT Filed: Feb. 20, 2015
(86) PCT No.: PCT/EP2015/053635

§ 371 Date: Aug. 17, 2016

(30) Foreign Application Priority Data
Feb. 21, 2014 (EP) 14156190.2

(51) Int. Cl. C08J 5/10; C08K 7/14; C08J 5/04; C08K 5/00; C08K 3/16; C08K 5/20; C08K 3/00

(52) U.S. Cl. CPC C08J 5/10; C08K 5/20; C08K 7/14; C08K 3/0041; C08K 5/005; C08K 3/16; C08J 5/043; C08K 2201/003; C08K 2201/004; C08J 2377/02

(57) ABSTRACT

The present invention relates to compositions based on long fiber reinforced polyamides, to a method of producing these compositions and also to articles of manufacture that are obtainable from long fiber reinforcements impregnated with a thermoplastic melt based on PA6 or PA66 or based on copolyamides of PA6 or PA66, wherein the thermoplastic melt contains at least one thermal stabilizer combined with at least one ester wax and/or with at least one amide wax.

The present invention relates to compositions based on long fiber reinforced polyamides, to a method of producing these compositions and also to articles of manufacture that are obtainable from long fiber reinforcements impregnated with a thermoplastic melt based on PA6 or PA66 or based on copolyamides of PA6 or PA66, wherein the thermoplastic melt contains at least one thermal stabilizer combined with at least one ester wax and/or with at least one amide wax.

### PRIOR ART

The reinforcement of articles of manufacture that are based on thermoplastic molding materials has been established art for many years. Typically, to produce thermoplastic compositions, chopped glass fibers are added to the thermoplastic melt in order to improve the mechanical properties of articles to be manufactured therefrom. The employment of chopped glass fibers in polyamide molding materials then leads to distinctly enhanced stiffnesses and strengths for the articles as compared with articles without chopped glass fibers. The chopped glass fibers employed are typically from 2 to 8 mm in length. Owing to the shearing involved in any mixing operation, however, the chopped glass fibers are broken down into distinctly shorter units. In consequence, the mean of the chopped glass fiber length distribution after any mixing of the components is usually located within the range from 100 to 500 μm [Engineering Thermoplastics 4. Polyamides [in German], eds.: G. W. Becker and D. Braun, Carl Hanser Verlag, 1998, pp. 102-107].

Owing to this shortening of average fiber lengths in a mixing process, compositions comprising polyamide and chopped glass fibers do not always meet the higher strengths and stiffnesses expected of the articles to be manufactured therefrom.

Long fiber reinforcements, by contrast, do deliver distinctly better mechanical properties for the articles to be manufactured therefrom. Different methods have therefore been developed so that long fiber reinforcements may, for example, be impregnated with a thermoplastic polyamide matrix and thereby be formed into an article of manufacture. An intermediate step in many of these processes involves the fabrication of a semi-finished article which is subsequently molded into a finished article in one or more further processing steps. [K. Brast, thesis [in German] “Processing of Long Fiber Reinforced Thermoplastics by Direct Plastification/Pressing”, Rheinisch-Westfälische Technische Hochschule Aachen, 2001]

U.S. Pat. No. 7,977,449 B2 thus describes a pellet material based on a polyamide matrix having a highly branched molecular structure and having long fibers aligned parallel to the length of the individual pellets and a method wherein long fibers and a polyamide matrix having a highly branched molecular structure are brought into contact.

U.S. Pat. No. 8,476,355 B2 describes a method wherein glass fibers from 5 to 20 mm in length are impregnated with a thermoplastic resin of low viscosity and then the mixture is added to a thermoplastic resin of higher viscosity.

WO 2011/134930 A1 further describes thermoplastic polyamide molding materials comprising a fibrous reinforcing agent having a fiber length of 3 to 24 mm and further comprising an apolar polyolefin based on ethylene or propylene and optionally also nanoparticulate oxide or oxide hydrate.

However, the problem not addressed in the cited prior art is that of emissions from the polyamide melt used to impregnate long fiber reinforcements in the methods described therein.

U.S. Pat. No. 5,204,396 reduces such emissions from long fiber reinforced polyamide molding materials in such processes in the form of smoke by the employment of processing aids, preferably metal salts of fatty acids having 22 to 32 carbon atoms, in particular by the employment of lithium, zinc, calcium or aluminum salts of behenic acid, triacontanoic acid, dotriacontanoic acid or erucic acid. However, notwithstanding usage of processing aids known from U.S. Pat. No. 5,204,396, long fiber reinforced polyamide melts are still prone to give significant emissions.

EP 2573138 A1 relates to polyamide molding materials for production of fiber, film/sheet and shaped articles. The examples described therein relate inter alia to molding materials comprising nylon 6, continuous glass fiber strands, N,N′-ethylenebisstearamide as amide wax and also a heat stabilizer.

US 2005/250885 A1 discloses compositions based on long fiber reinforced polyamides based on PA6 and PA66, the compositions of Examples 27 to 30 further comprising long glass fibers, an amide wax and a heat stabilizer.

US 2014/051795 A1 further teaches inter alia compositions based on long fiber reinforced PA6/PA66 blends (table 3), which further comprise a heat stabilizer and an amide wax.

DE 10 2008 052055 A1 describes a composition comprising nylon 6, glass fibers (CS7928 from Lanxess Deutschland GmbH), montan ester wax and also the employment of potassium bromide and copper(1) iodide as heat stabilizers.

US 2009/069478 A1 relates to polyamide compositions having reduced emissions in processes. These compositions comprise PA6 copolyamide, ester wax and also ECS03-615 glass fibers 3 mm in fiber length and 9 μm in fiber diameter.

The problem addressed by the present invention was therefore that of providing compositions based on long fiber reinforcement whence articles of manufacture are obtainable without emissions or at least reduced emissions as compared with prior art methods.

Emissions for the purposes of the present invention are extremely to moderately volatile organic substances, preferably hydrocarbons, alcohols, aldehydes, organic acids and also monomers of the ingredient polyamides and/or decomposition products thereof. The emissions to be prevented or reduced in the present invention preferably concern smoke-producing decomposition products of the polyamide(s) used. In the context of the present application, caprolactam monomer was measured as an emission of PA6. The PA66 monomers to be determined as emissions in the context of the present application are either hexane-1,6-diamine or adipic acid. Evolution of smoke is characterized in the context of the present invention by determining the optical density of smoke in accordance with EN ISO 5659-2, for which the composition to be tested in pellet form is exposed to such a radiative intensity by heating to 280° C.

Surprisingly, it was found that such emissions from the processing of a polyamide melt comprising long fibers are distinctly reduced by admixing at least one thermal stabilizer and by using at least one amide wax and/or at least one ester wax as a demolding assistant.

The solution to the problem and hence a subject matter of the present invention is accordingly a composition comprising as ingredients
a) PA6 or PA66 or a copolyamide of PA6 or PA66,
b) at least one thermal stabilizer, and
c) at least one amide wax and/or at least one ester wax, and also
d) a long fiber reinforcement which comprises not less than 90 wt % of fibers having a fiber diameter in the range from 5 to 25 μm, of which not less than 80% of fibers have a length of at least 5 mm, and the long fiber reinforcement contains up to 10 wt % of at least one added-substance material.

For avoidance of doubt, the purview of the invention encompasses all the definitions and parameters recited hereinbelow in general terms or in preferred ranges in any combination.

The present invention preferably provides compositions comprising as ingredients
a) 15 to 89.79 wt % of PA6 or PA66 or a copolyamide of PA6 or PA66,
b) 0.01 to 2 wt % of at least one thermal stabilizer, and
c) 0.05 to 3 wt % of at least one amide wax and/or at least one ester wax, and also
d) 10.1 to 80 wt % of long fiber reinforcement which comprises not less than 90 wt % of fibers having a fiber diameter in the range from 5 to 25 μm, of which not less than 80% of fibers have a length of at least 5 mm, and the long fiber reinforcement contains up to 10 wt % of at least one added-substance material,
   wherein the sum total of all weight percentages of components a) to d) is always 100 and the long fiber reinforcement contains up to 10 wt % of at least one added-substance material.

The compositions of the present invention are obtained by mixing components a) to d), to be employed as ingredients, in at least one mixing tool. Molding materials are obtained as Intermediate products here. The molding materials may either consist exclusively of components a) to d) or alternatively contain further components in addition to components a) to d). In this case, components a) to d) shall be varied within the scope of the recited quantitative ranges such that the sum total of all weight percentages always comes out as 100.

In the context of the present invention, “in a mixing tool” is preferably to be understood as meaning in at least one mixing tool, more preferably in one mixing tool, most preferably in one extruder with extruder screw. In a pressing tool is preferably to be understood as meaning in at least one pressing tool, more preferably in one pressing tool, most preferably in one double belt press. A tool outlet is preferably to be understood as meaning at least one tool outlet, more preferably one tool outlet, yet more preferably one extruder outlet, specifically one die, yet still more preferably one wide slot die.

In one embodiment, the compositions according to the present invention comprise granules. These are preferably at least 5 mm in length.

In a further embodiment, the compositions of the present invention are intermediate products or continuous fiber reinforced semi-finished goods to be produced from the granules by extrusion or injection molding or, respectively, by pressing operations, and also articles of manufacture, moldings or component parts to be in turn produced from these intermediate products and continuous fiber reinforced semi-finished goods.

Continuous fiber reinforced semi-finished goods for the purposes of the present invention are also referred to in the prior art as sheet-shaped or fiber reinforced composite materials, laminated bodies or laminates, fiber composite structure, semi-finished fiber composite product, semi-finished textile product, fiber composite thermoplastic, composite (structure), organosheet, etc.

When the articles provided by the present invention are continuous fiber reinforced semi-finished goods or are articles, component parts or moldings to be manufactured therefrom, the long fiber reinforcement and the long fibers used therein have a length of up to several meters. Any limitation of the long fiber length in the long fiber reinforcement and/or in the articles provided by the present invention in the form of semi-finished goods and also the articles to be manufactured from these semi-finished goods, is at most dictated by the handleability, the transportation, etc., of these finished and semi-finished articles.

In compositions according to the present invention which are in the form of pellets, the long fibers not only have the fiber diameter in the range from 5 to 25 μm and 80% a minimum length of at least 5 mm but preferably additionally have a parallel alignment relative to the length of the individual pellets.

The pellets more preferably have a cylindrical shape or a cube shape. A cylindrical shape is especially preferable.

The length of the long fibers in the pellets of the present invention is preferably in the range from 5 mm to 20 mm. Subsequent processing operations, in particular mixing processes, in a mixing tool, in an extrusion process or in injection molding, may by the very nature of the processing operation cause shortening of the long fibers to lengths in the range from 100 to 150 μm.

Since most processors require plastic to be supplied in the form of pellet material, pelletization is becoming ever more important. A fundamental distinction is made between hot cut and cold cut. Pellet shapes resulting therefrom differ according to the processing. Hot cut results in pellet material in lenticular shape or beads, while cold cut results in pellet material in cylindrical shapes or cube shapes. Pellet shaped compositions according to the present invention are preferably obtained by cold cut. To this end, the strand of molding material exiting a mixing tool after being obtained by mixing components a) to d) in said mixing tool, preferably the strand of extrudate exiting from an extruder, is pulled directly after the mixing tool outlet, preferably after at least one die leading out of an extruder, through a water bath and then, in the solid state, is cut by a pelletizer, preferably by a rotor, into the length desired for the pellet material to be produced.

The present invention also provides a method of preventing or reducing emissions during the processing of long fiber reinforced molding materials based on PA6 or PA66 or on copolyamides of PA6 or PA66 by mixing at least one thermal stabilizer with at least one amide wax and/or with at least one ester wax and the long fiber reinforcement(s) comprise not less than 90 wt % of fibers having a fiber diameter in the range from 5 to 25 μm, of which not less than 80% have a fiber length of at least 5 mm, and the long fiber reinforcement contains up to 10 wt % of at least one added-substance material.

Preference is given to preventing or reducing emissions from molten molding materials based on PA6 and/or PA66 or on copolyamides of PA6 or PA66. These melts are preferably generated in processing operations on the molding materials based on PA6 or PA66 or on copolyamides of PA6 or PA66, preferably in extrusion processes, in injection molding or in a pressing operation in a pressing tool, preferably in double belt presses.

The present invention further provides a method of producing the compositions of the present invention, characterized in that by way of ingredients
a) nylon 6 (PA6) or nylon 66 (PA66) or a copolyamide of PA6 or PA66,
b) at least one thermal stabilizer, and
c) at least one amide wax and/or at least one ester wax
   (Ia) are mixed and melted in a mixing tool (1) at temperatures in the range from 220 to 400° C., preferably in the range from 240 to 380° C., more preferably in the range from 250 to 350° C. and at pressures in the range from 2 to 50 bar, preferably in the range from 5 to 40 bar, more preferably in the range from 10 to 35 bar,
   (Ib) thereafter component d) is admixed in the form of fibers to the melt comprising said components a) to c) in said mixing tool (1), and finally
   (Ic) the melt comprising said components a) to d) is exported from said mixing tool (1) and optionally subjected to further processing steps,
   or after method step (Ia)
   (IIb) the melt comprising said components a) to c) is transferred from said mixing tool (1) into a mixing tool (2) and said component d) is added in the form of fibers or yarns to the melt in the mixing tool (2) and impregnated with said melt, and
   (IIc) thereafter the melt comprising said components a) to d) in said mixing tool (2) is exported via a mixing unit outlet and optionally subjected to further processing steps,
   or after method step (Ia)
   (IIIb) said component d) is metered in the form of fibers or yarns into the same mixing tool (1) of method step (Ia), and
   (IIIc) thereafter the melt comprising said components a) to d) is exported via a mixing tool outlet and optionally subjected to further processing steps,
   or after method step (Ia)
   (IVb) the melt out of said mixing tool (1) is contacted via a mixing tool outlet with at least two plies of the two-dimensional component d), and
   (IVc) this mixture of components a) to d) is transferred into a pressing tool and pressmolded together to form an article of manufacture,
   wherein component d) is a long fiber reinforcement which comprises not less than 90 wt % of fibers having a fiber diameter in the range from 5 to 25 μm, of which not less than 80% of fibers have a length of at least 5 mm.

Versions (IVb) and (IVc) provide articles which preferably have the shape of two-dimensional semi-finished goods and are referred to as continuous fiber reinforced semi-finished goods.

The product of the method according to the present invention is in the context of the present invention also referred to as “an impregnate”. Impregnating for the purposes of this invention is to be understood as meaning the step wherein component d) is brought into contact, and mixed, with the melt comprising components a) to c).

According to the present invention, the present invention encompasses the versions:
i) (Ia), (Ib) and (Ic)
ii) (Ia), (IIb) and (IIc)
iii) (Ia), (IIIb) and (IIIc) and also
iv) (Ia), (IVb) and (IVc)
   of the method.

In one embodiment, method steps (Ic), (IIc) or (IIIc) are followed by a further processing step (V) of portioning the impregnate.

In one embodiment, a further processing step (VI) following method step (V) comprises the portioned impregnate being transferred into a molding press and converted therein into the shape of an article, of a semi-finished good or of a component part.

Compositions according to the prior art tend to produce high emissions particularly in the course of the method steps of exporting, portioning or in the course of transfer into the further processing of an impregnate. Surprisingly, these emissions are distinctly reduced for long fiber reinforced PA6 or PA66 based compositions or compositions based on copolyamides of PA6 or PA66 by using the combination which the present invention provides between at least one thermal stabilizer and at least one amide wax and/or at least one ester wax.

In the version of the method that features steps (Ia), (IIb) and (IIc), a composition comprising components a) to c) is initially, in method step (Ia), metered into at least one mixing tool (1), melted therein and mixed. The melt is then transferred into at least one mixing tool (2) and, in method step (IIb), the component d) is added to and mixed with the melt, component d) in this case being employed in the form of fibers or yarns. The number of yarns can be used to control the fiber content of the resulting composition. Following impregnation of component d) in mixing tool (2), the impregnate is exported via a mixing tool outlet, preferably an extruder outlet, more preferably a die, most preferably a wide slot die. This version of the method is characterized in that steps (Ia), (IIb) carried out in two different mixing tools.

In the version of the method that features steps (Ia), (IIIb) and (IIIc), a composition comprising components a) to c) is initially, in method step (Ia), metered into a mixing tool (1), melted and mixed therein and, in method step (IIIb), component d) is metered into the same mixing tool (1), component d) being employed in the form of fibers or yarns. Following the impregnation of component d), the impregnate is exported via at least one mixing tool outlet, preferably an extruder outlet, more preferably a die, most preferably a wide slot die. In this version of the method, steps (Ia) and (IIIb) are carried out in the same mixing tool (1).

In one preferred embodiment, a composition comprising components a) to c) is employed as premix in all versions of the method.

In one preferred embodiment, component d) is in all versions of the method preheated before metering.

In preferred embodiments, all versions of the method, in particular the version of the method that is characterized by steps (Ia), (IVb) and (IVc), utilizes component d) in a two-dimensional form and impregnates it with a melt comprising components a) to c).

Component d) in two-dimensional form is preferably employed in the form of non-crimp fabrics, wovens, braids, weft-knitted fabrics produced by weft knitting with independently movable needles, stitched fabrics or nonwovens, more preferably wovens, non-crimp fabrics or nonwovens, yet more preferably nonwovens, wovens or non-crimp fabrics formed of glass fibers or carbon fibers, especially preferably nonwovens, wovens or non-crimp fabrics composed of E-glass fibers.

In the version of the method that features steps (Ia), (IVb) and (IVc), a composition comprising components a) to c) is in method step (Ia) metered into a mixing tool (1), melted, mixed and in method step (IVb) brought into contact via a mixing unit outlet, preferably an extruder outlet, more preferably a die, most preferably a wide slot die, out of the mixing tool (1) with at least two plies of the two-dimensional component d). In a subsequent method step (IVc), this mixture is transferred into at least one pressing tool, preferably into at least one double belt press, where the impregnation of component d) is concluded and the impregnate is brought into the shape of an article of manufacture, preferably into the shape of a two-dimensional semi-finished good.

The method featuring method steps (Ia), (IVb) and (IVc) is preferably also employed for the manufacture of finished or semi-finished articles having three or more plies of component d) by exporting a defined number n of extrudates comprising components a) to c) and interleaving them between n+1 plies of component d).

The embodiments of the method according to the present invention preferably all employ extruders as mixing tools. However, the person skilled in the art is free to employ alternative mixing tools in the respective steps that are suitable for obtaining an optimal mixing outcome in respect of a mixture of components a) to c) or a) to d) in the compositions of the present invention. An extruder is a preferred mixing tool for the purposes of the present invention.

Extruders to be employed with preference as mixing tools (1) and (2) are single screw extruders or twin screw extruders and also their respective sub-groups, most preferably conventional single screw extruders, actively conveying single screw extruders, counter-rotatory twin screw extruders or corotatory twin screw extruders. Extruders (1) and (2) to be employed as mixing tools are known to the person skilled in the art from Engineering Thermoplastics 4. Polyamides [in German], eds.: G. W. Becker and D. Braun, Carl Hanser Verlag, 1998, pp. 311-314 and also K. Brast, thesis [in German] “Processing of Long Fiber Reinforced Thermoplastics by Direct Plastification/Pressing”, Rheinisch-Westfälische Technische Hochschule Aachen, 2001, pp. 30-33.

Mixing tool (2) to be employed in the version of the method that features steps (Ia), (IIb) and (IIc) is preferably operated at temperatures in the range from 250 to 350° C. and at pressures in the range from 10 to 35 bar.

The version of the method that features steps (Ia), (IVb) and (IVc) utilizes a pressing tool, preferably at least one double belt press, in method step (IVc). The pressing tool, preferably the one or more than one double belt press, is preferably operated at temperatures in the range from 250 to 350° C. and at pressures in the range from 10 to 35 bar. Double belt presses useful for the purposes of the present invention are for example available from Hymmen Industrieanlangen GmbH, Bielefeld, Germany.

### Component a)

The polyamides to be employed as component a) are PA6 or PA66 or a copolyamide of PA6 or PA66.

Polyamides are designated in the context of the present application in line with international standardization where the initial numeral(s) of a designation indicate(s) the number of carbon atoms in the starting diamine and the last numeral(s) indicate(s) the number of carbon atoms in the dicarboxylic acid. Where only one number is indicated, as in the case of PA6, this is to be understood as meaning that the starting material is one α,ω-amino carboxylic acid or the lactam derived therefrom, i.e., ε-caprolactam in the case of PA6; reference is otherwise made to H. Domininghaus, [in German] The Plastics and Their Properties, pages 272 ff., VDI-Verlag, 1976.

The polyamide to be used as component a) preferably has an ISO 307 viscosity number—determined in a 0.5 wt % solution in 96 wt % sulfuric acid at 25° C.—in the range from 80 to 180 ml/g, more preferably in the range from 90 to 160 ml/g.

Component a) is more preferably PA6 and most preferably a PA6 having an ISO 307 viscosity number—determined in a 0.5 wt % solution in 96 wt % sulfuric acid at 25° C.—between 95 and 120 ml/g.

The polyamides to be used in the compositions of the present invention are obtainable by various methods and synthesized from different building blocks. A multiplicity of procedures are known for preparing polyamides and they utilize different monomeric building blocks and also various chain transfer agents to establish a desired molecular weight or else monomers having reactive groups for later intended aftertreatments, depending on the end product desired.

Industrially relevant methods of preparing the polyamides to be employed according to the present invention usually proceed via a polycondensation in the melt. For the purposes of the present invention, the hydrolytic chain growth addition polymerization of lactams also counts as a polycondensation.

The PA6 and/or PA66 polyamides to be used as component a) are preferably semicrystalline polyamides having a melting point of not less than 180° C. Semicrystalline polyamides are said by DE 10 2011 084 519 A1 to have a melt enthalpy of 4 to 25 J/g, as measured by the DSC procedure of ISO 11357 in the 2nd heating and by integration of the melt peak. In contradistinction thereto, amorphous polyamides have a melt enthalpy of less than 4 J/g, measured by the DSC procedure of ISO 11357 in the 2nd heating and by integration of the melt peak.

### Component b)

Component b) preferably utilizes at least one component from the group of copper compounds, of sterically hindered phenols, of phosphites, of phosphates, of hydroquinones, of aromatic secondary amines, of substituted resorcinols, of salicylates, of benzotriazoles or of benzophenones, and also variously substituted representatives of these components and/or mixtures thereof.

Preferred copper compounds are copper halides which in turn are preferably employed in combination with alkali metal and/or alkaline earth metal halides. Particular preference for the purposes of the present invention is given to employing at least one copper halide from the group copper chloride, copper bromide and copper iodide in combination with at least one sodium or potassium halide from the group sodium chloride, sodium bromide, sodium iodide, potassium chloride, potassium bromide and potassium iodide. It is especially preferred to employ copper(I) iodide together with potassium bromide.

Component b) preferably also utilizes sterically hindered phenols and/or copper halides in combination with alkali metal and/or alkaline earth metal halides.

Sterically hindered phenols are compounds of phenolic structure which have one or more than one sterically bulky group on the phenolic ring. Sterically bulky groups for the purposes of the present invention are preferably tert-butyl groups, isopropyl groups and aryl groups substituted with sterically bulky groups, and are in particular tert-butyl groups.

Very particularly preferred sterically hindered phenols are selected from the group 2,2′-methylenebis(4-methyl-6-tert-butylphenol), 1,6-hexanediol bis[3-(3,5-di-tert-butyl-4-hydroxyphenyl)propionate], pentaerythritol tetrakis[3-(3,5-di-tert-butyl-4-hydroxyphenyl)-propionate], distearyl 3,5-di-tert-butyl-4-hydroxybenzylphosphonate, 2,6,7-trioxa-1-phosphabicyclo[2.2.2]oct-4-yl-methyl 3,5-di-tert-butyl-4-hydroxyhydrocinnamate, 3,5-di-tert-butyl-4-hydroxyphenyl-3,5-distearylthiotriazylamine, 2-(2′-hydroxy-3′-hydroxy-3′,5′-di-tert-butylphenyl)-5-chlorobenzotriazole, 2,6-di-tert-butyl-4-hydroxymethylphenol, 1,3,5-trimethyl-2,4,6-tris(3,5-di-tert-butyl-4-hydroxybenzyl)benzene, 4,4′-methylenebis(2,6-di-tert-butylphenol), 3,5-di-tert-butyl-4-hydroxybenzyldimethylamine.

Especially preferred sterically hindered phenols are selected from the group 2,2′-methylenebis(4-methyl-6-tert-butylphenol), 1,6-hexanediolbis(3,5-di-tert-butyl-4-hydroxyphenyl]propionate (Irganox® 259), pentaerythrityl tetrakis[3-(3,5-di-tert-butyl-4-hydroxyphenyl)propionate] and also N,N′-hexamethylenebis-3,5-di-tert-butyl-4-hydroxyhydrocinnamide (Irganox® 1098) and the above-described Irganox® 245 from BASF SE, Ludwigshafen, Germany.

For the purposes of the present invention, it is especially very particularly preferable to employ N,N′-hexamethylenebis-3,5-d-tert-butyl-4-hydroxyhydrocinnamide [CAS No. 23128-74-7], available from BASF SE, Ludwigshafen, Germany as Irganox® 1098, as sterically hindered phenol.

### Component c)

The amide waxes to be used as component c) are preferably compounds obtainable via a condensation reaction of long chain carboxylic acids with mono- or polyfunctional amines.

It is preferable according to the present invention to employ branched or linear long chain aliphatic carboxylic acids having more than 11 carbon atoms to synthesize the amide waxes. It is particularly preferable for the chain length of the aliphatic carboxylic acids to be in the range from 12 to 36 carbon atoms. Very particular preference is given to aliphatic carboxylic acids whose chain length is in the range from 14 to 22 carbon atoms. Linear saturated aliphatic carbon atoms having a chain length in the range from 14 to 22 carbon atoms are especially preferred. It is especially particularly preferable to employ at least one carboxylic acid from the group lauric acid, isotridecanoic acid, myristic acid, palmitic acid, margaric acid, stearic acid, isostearic acid, arachidic acid, behenic acid, lignoceric acid, cerotic acid, montanoic acid, melissic acid, myristoleic acid, palmitoleic acid, petroselic acid, oleic acid, elaidic acid, vaccenic acid, gadoleic acid, icosenoic acid, cetoleic acid, erucic acid, nervonic acid, linoleic acid, linolenic acid, calendula acid, eleostearic acid, punicic acid, arachidonic acid, timmodonic acid, clupanodonic acid and cervonic acid and also their technical grade mixtures. It is especially very particularly preferable to employ at least one carboxylic acid from the group margaric acid, stearic acid, arachidic acid and behenic acid; stearic acid is especially preferred.

The aliphatic carboxylic acids employed to synthesize the amide waxes to be employed as component c) may be employed alone or in admixture. Preference is given to the employment of technical grade aliphatic carboxylic acids which are normally present as a mixture of carboxylic acids having different chain lengths, with one chain length dominating. Particular preference is given to employing technical grade stearic acid which contains in the main stearic acid and also minor amounts of palmitic acid and other carboxylic acids.

By way of mono- or polyfunctional amines there are used alkylamines having one or more amino groups wherein the amino groups may be primary or secondary in nature and the alkyl component may be saturated or unsaturated and may contain further substituents. Preference is given to using alkylamines having terminal primary amino groups. Particular preference is given to linear saturated alkylamines having two terminal primary amino groups. It is very particularly preferable to employ ethylenediamine to synthesize the amide waxes to be employed according to the present invention.

The ester waxes to be employed as component c) are compounds obtainable via a condensation reaction of at least one long chain monofunctional aliphatic carboxylic acid with an alcohol.

Preferred ester waxes for the purposes of the present invention are esters of the above-described aliphatic carboxylic acids having more than 11 carbon atoms.

The alcohol component of the ester wax preferably utilizes saturated or unsaturated alkyl compounds having one or more than one hydroxyl group wherein the hydroxyl groups are primary, secondary or tertiary. Particular preference is given to employing saturated alkyl compounds having 1 to 8 primary or secondary hydroxyl groups. Very particular preference is given to employing linear saturated alkyl compounds having 1 to 4 primary or secondary hydroxyl groups.

It is especially preferred to employ at least one alcohol from the series erythritol, penta-erythritol, glycerol, ethylene glycol and also technical grade mixtures thereof.

It is especially particularly preferred to employ N,N′-ethylenebisstearamide as ester wax of component c). It is especially very particularly preferred to employ N,N′-ethylenebisstearamide prepared from technical grade stearic acid which is a mixture of pure stearic acid with further carboxylic acids, mainly palmitic acid.

### Component d)

A long fiber reinforcement for use as component d) within the meaning of the present invention comprises not less than 90 wt % of fibers whereof not less than 80% are not less than 5 mm, preferably not less than 20 mm, in length. The Individual fibers of the long fiber reinforcement have on average a diameter in the range from 5 to 25 μm, preferably from 5 to 20 μm, more preferably from 8 to 18 μm. The upper limit to fiber length in the long fiber reinforcement is, as described above, dictated in the particular article of manufacture by the manner of processing.

The person skilled in the art will know in principle about the employment of long fiber reinforcements in the manufacture of fiber reinforced plastic articles, for example from DE 19756126 A1, the content of which is hereby fully incorporated by the present application. DE 10 2007 007 443 A1 further discloses a method of producing plastic sheets incorporating a long fiber reinforcement wherein a mixed nonwoven is employed. Semi-finished thermoplastic fiber-matrix products are said by Schürmann, [in German] “Designing with Fiber-Plastic Composites”, Springer-Verlag Berlin Heidelberg 2005, 2007, pages 156-157 to subdivide into the following groups:
long fiber reinforced systems:
   GMT: glass mat reinforced thermoplastics;
   LFT: long fiber reinforced thermoplastics
continuous fiber reinforced systems: thermoplastic prepregs

By way of long fiber reinforcement it is preferably at least one long fiber from the group of
glass fibers (Oberbach, Baur, Brinkmann, Schmachtenberg, “Saechtling Kunststoff Taschenbuch”, Carl Hanser Verlag Munich Vienna 2004, pages 644-647),
metalized glass fibers
carbon fibers (Oberbach, Baur, Brinkmann, Schmachtenberg, “Saechtling Kunststoff Taschenbuch”, Carl Hanser Verlag Munich Vienna 2004, page 648),
natural fibers (Oberbach, Baur, Brinkmann, Schmachtenberg, “Saechtling Kunststoff Taschenbuch”, Carl Hanser Verlag Munich Vienna 2004, pages 650-652, 778-779),
polymeric fibers, in particular high temperature polymeric fibers (Oberbach, Baur, Brinkmann, Schmachtenberg, “Saechtling Kunststoff Taschenbuch”, Carl Hanser Verlag Munich Vienna 2004, pages 648-650), preferably aramid fibers (Kunststoff-Handbuch, vol. 3/4, pages 106-107, Carl Hanser Verlag Munich Vienna 1998),
steel fibers,
mineral fibers, in particular basalt fibers
   which is employed.

Long fibers to be employed as component d) for the purposes of the present invention may be continuous fibers which, according to DIN 60000, represent a line-shaped construct of virtually infinite length that is processable in a textile manner. However, long fibers are said by “http//de.wikipedia.org/wiki/Langfaser” to also include natural fibers having a length of above 100 mm. They constitute the target product of traditional fiber opening and are costlier to obtain and process as compared with the production of short fibers, where the complete fibers (the entire line) are utilized. They are used particularly in textile manufacture. Only filaments such as, for example, silk or manufactured fiber filaments, which are only limited by the bobbin volume, are longer than long fibers. It is filaments in the case of man-made fibers, whereas the only naturally occurring textile continuous fiber is silk. For the purposes of the present invention, the term “long fiber” is also applied to the abovementioned fibers to be used according to the present invention. When the impregnate is not a pellet material, the long fibers of long fiber reinforcement d) preferably have a length in the range from 100 mm to 2000 mm.

According to the present invention, the long fiber reinforcement to be employed as component d) and/or the long fibers to be employed therefor and/or non-crimp fabrics, wovens, braids, weft-knitted fabrics produced by weft knitting with independently movable needles, stitched fabrics, nonwovens, fiber tows or rovings produced therefrom are surface modified with at least one added-substance material.

Preferred added-substance materials to the long fiber reinforcement shall be selected from the group consisting of binders, size and tying fibers.

It is preferable in the present invention for component d), or the long fibers employed in the manufacture of component d), to be coated with a size as added-substance material. It is particularly preferable for the size content to be in the range from 0.1 to 1 wt % of the overall weight of the long fiber reinforcement and/or of the long fibers to be employed.

It is particularly preferable for the size to be employed as added-substance material to be an adhesion promoter and/or adhesion promoter system, most preferably a silane based adhesion promoter. In one alternative embodiment, an add-on of an added-substance material or a pretreatment with an added-substance material is not absolutely required.

When glass fibers are used in particular, polymer dispersions, emulsifiers, film formers, in particular polyepoxy, polyether, polyolefin, polyvinyl acetate, polyacrylate or polyurethane resins or mixtures thereof, branches, further adhesion promoters, lubricants, pH buffers and/or glass fiber processing aids, in particular wetting agents and/or antistats, are preferably also used in addition to silanes. The further adhesion promoters, lubricants and other auxiliary materials, methods of producing the sizes, methods of sizing, i.e., application of an added-substance material, and postprocessing of the glass fibers are known and for example described in K. L. Löwenstein, “The Manufacturing Technology of Continuous Glass Fibres”, Elsevier Scientific Publishing Corp., Amsterdam. London, New York, 1983. The glass fibers are sizable via any procedures, preferably by means of suitable devices, in particular with sprayed or roll applicators. The glass filaments pulled at high speed from spinneret dies may have sizes applied to them as an added-substance material immediately after their solidification, i.e., even before winding up or cutting. However, it is also possible to size the fibers with an added-substance material in a dip bath following the spinning process.

The glass fibers to be employed in the present invention with especial preference in the long fiber reinforcement d) preferably either have a circular cross sectional area and a filament diameter in the range from 5 to 25 μm, preferably in the range from 6 to 18 μm, more preferably in the range from 9 and 15 μm, or a flat shape and a noncircular cross sectional area having a width in the range of 6-40 μm for the principal cross sectional axis and a width in the range of 3-20 μm for the secondary cross sectional axis. The glass fibers are preferably selected from the group of E-glass fibers, A-glass fibers, C-glass fibers, D-glass fibers, S-glass fibers and/or R-glass fibers.

Very particular preference for use as added-substance material is given to silane based adhesion promoters for pretreating the long fibers to be used in component d). They are preferably silane compounds of general formula (I)

(X—(CH₂)_{q})ₖ—Si—(O—CᵣH₂ᵣ₊₁)₄₋ₖ (I)

where the substituents have the following meanings:

### X:

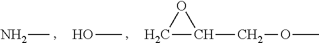

q: an integer from 2 to 10, preferably from 3 to 4,
r: an integer from 1 to 5, preferably from 1 to 2,
k: an integer from 1 to 3, preferably 1.

Very particularly preferable adhesion promoters are monomeric organofunctional silanes, in particular 3-aminopropyltrimethoxysilane, aminobutyltrimethoxysilane, 3-aminopropyl-triethoxysilane, aminobutyltriethoxysilane, 3-aminopropyltrismethoxyethoxysilane, 3-aminopropylmethyldiethoxysilane, N-methyl-2-aminoethyl-3-aminopropyltrimethoxysilane, N-methyl-2-aminoethyl-3-aminopropylmethyldimethoxysilane, N-methyl-3-amino-propyltrimethoxysilane, 3-glycidyloxypropyltrimethoxysilane, 3-methacryloyloxypropyl-trimethoxysilane, 3-mercaptopropyltrimethoxysilane, vinyltriethoxysilane, vinyl-trimethoxysilane, N-β-(aminoethyl)-γ-aminopropyltrimethoxysilane (Dynasilan® Damo from Hüls AG), N-β-(aminoethyl)-γ-aminopropyltriethoxysilane, N-β-(aminoethyl)-γ-aminopropylmethyldimethoxysilane, N-β-(aminoethyl)-N-β-(aminoethyl)-γ-aminopropyl-trimethoxysilane.

Especially preferred adhesion promoters are silane compounds from the group aminopropyltrimethoxysilane, aminobutyltrimethoxysilane, aminopropyltriethoxysilane and aminobutyltriethoxysilane and also the corresponding silanes which contain a glycidyl group in formula (I) as substituent X.

To surface coat the glass fibers to be used as long fibers, the silane compounds to be used as added-substance material are preferably employed in amounts ranging from 0.025 to 0.4 wt %, more preferably from 0.05 to 0.3 wt %, based on the glass fibers.

Preference is given to employing long fiber reinforcements wherein two or more long fibers are gathered together to form a yarn. Preference is given to employing yarns comprising E-glass fibers at 30 to 5000 tex and carbon fibers having 1000 to 24 000 fibers per yarn, more preferably having 2000 to 4000 fibers per yarn.

The preference in the cases of (IIb) and (IIIb) is for the use of yarns having low, high or zero twist long fibers. Particular preference is given to using yarns having zero twist long fibers.

Preferred long fiber reinforcements for the purposes of this invention take the form of a one-dimensional, two-dimensional or three-dimensional structure.

One-dimensional long fiber reinforcements for the purposes of this invention are the above-described long fibers and yarns which are employed directly in the method of the present invention.

Two-dimensional long fiber reinforcements for the purposes of this invention are nonwovens, non-crimp fabrics, wovens, braids and weft-knitted fabrics produced by weft knitting with independently movable needles that contain the yarns and long fibers to be employed above in the manner of the present invention. Preferred two-dimensional long fiber reinforcements are nonwovens, wovens and non-crimp fabrics.

Three-dimensional long fiber reinforcements for the purposes of this invention are nonwovens, non-crimp fabrics, wovens, braids and weft-knitted fabrics produced by weft knitting with independently movable needles that contain the above-described long fibers and yarns and where some or all of the long fibers and yarns exhibit an undulation. Preferred three-dimensional long fiber reinforcements are round braids, more preferably biaxial or triaxial round braids.

Long fibers and/or long fiber wovens to be employed as component d) in the present invention are available as StarRov® from Johns Manville, in particular StarRov® LFT Plus PR 440 2400 871.

Size and any additional binders, in particular where the long fibers are in the form of non-crimp fabrics, wovens, braids, weft-knitted fabrics produced by weft knitting with independently movable needles, stitched fabrics, nonwovens, fibers tows or rovings (“Custom Tailored Reinforcing Textiles” [in German], Kunststoffe June 2003, Carl Hanser Verlag, pages 46-49), add up to not more than 10% of the weight of component d). It is preferable to employ as added-substance material at least one binder from the series acrylic resins, butadiene-styrene polymers, butadiene-acrylonitrile polymers, polyurethanes, polyesters, polyamides or vinyl ester resins, more preferably as aqueous dispersions in the manufacture of the long fiber reinforcements to be employed for the purposes of the present invention.

Where non-crimp fabrics, wovens, braids, weft-knitted fabrics produced by weft knitting with independently movable needles, stitched fabrics or nonwovens are employed as long fiber reinforcement, tying fibers are preferably employed in order to improve the stability of the long fibers prior to impregnation with impregnate. Particular preference is given to the employment of tying fibers comprising glass or a thermoplastic polymer, in particular tying fibers comprising E-glass, polyamide or polyester. The person skilled in the art will know of the employment of tying fibers to enhance the stability of long fiber reinforcements from WO90/12911 A1 for example.

### Component e)

The compositions of the present invention and the molding materials obtainable therefrom by mixing the components may in one preferred embodiment further comprise, in addition to components a) to d), further additives other than components b) and c), as component e).

Further additives e) for the purposes of the present invention are preferably at least one component from the group of gamma ray stabilizers, of hydrolysis stabilizers, of antistats, of emulsifiers, of nucleating agents, of plasticizers, of processing aids, of impact modifiers, of elastomer modifiers, of lubricants, of demolding agents, of dyes or of pigments.

The additives recited and further useful as component e) are prior art and are found for example in the Plastics Additives Handbook, 5th Edition, Hanser-Verlag, Munich, 2001, pages 80-84, 546-547, 688, 872-874, 938, 966 by the person skilled in the art.

The amounts of component e) used are preferably from 0.01 to 20 wt %, more preferably from 0.01 to 10 wt % and most preferably from 0.01 to 5 wt %, all based on the entire composition, while at least one of components a), b), c) or d) is sufficiently reduced for the sum total of all weight percentages in the composition to always come out as 100.

The additives to be employed as component e) may be employed alone or in admixture and/or in the form of masterbatches. Further additives of component e) are preferably added to components a), b) and c) in the course of method step (Ia).

Where thermoplastic molding materials of the present invention are obtained as an intermediate product following method step (Ia), the sum total of all weight percentages is always 100 by the amounts of components a), b), c) and d), preferably of components a) and d), being reduced by that amount in which additives are added.

The impact modifiers or elastomer modifiers preferably employed as component e) in the present invention are very generally copolymers which are preferably constructed of two or more monomers from the group ethylene, propylene, butadiene, isobutene, isoprene, chloroprene, vinyl acetate, styrene, acrylonitrile and acrylic ester or methacrylic ester having 1 to 18 carbon atoms in the alcohol component. The copolymers may contain compatibilizing groups, preferably maleic anhydride or epoxide.

Dyes or pigments preferably employed as additive e) in the present invention are inorganic pigments, more preferably titanium dioxide, ultramarine blue, iron oxide, zinc sulfide or carbon black, and also organic pigments, more preferably phthalocyanines, quinacridones, perylenes and also dyes, more preferably nigrosine or anthraquinones, and also other colorants.

Nucleating agents preferably employed as additive e) in the present invention are sodium phenylphosphinate, calcium phenylphosphinate, aluminum oxide, silicon dioxide or talc, more preferably talc.

The present invention further also provides the method of using a mixture of at least one thermal stabilizer and at least one ester wax and/or at least one amide wax to reduce the emissions in processes in which long fiber reinforcements are impregnated with a thermoplastic melt which contains PA6 or PA66 or a copolyamide of PA6 or PA66, wherein the emissions concern hydrocarbons, alcohols, aldehydes, organic acids and also monomers of the polyamides to be used or their decomposition products, preferably caprolactam in the case of PA6 or either hexane-1,6-diamine or adipic acid in the case of PA66, and the evolution of smoke is characterized by determining the optical density of smoke in accordance with EN ISO 5659-2, for which the composition to be tested in pellet form is exposed to such a radiative intensity by heating to 280° C.

Preference is given to the method of using a mixture of at least one thermal stabilizer and at least one ester wax and/or at least one amide wax to reduce the emissions in processes in which long fiber reinforcements comprising up to 90 wt % of long fibers having a fiber diameter of 5-25 μm, of which not less than 80% of the fibers have a fiber length of at least 5 mm, and the long fiber reinforcements contain up to 10 wt % of further added-substance material, are impregnated with a thermoplastic melt to form an impregnate comprising not less than 30 wt % of PA6 or PA66 and/or a copolyamide of PA6 or PA66, to form an impregnate.

Preferred processes in which long fiber reinforcements are impregnated with a thermoplastic melt are exporting, portioning or transferring the impregnate into further processing operations.

The preference in the present invention is for the use of copper(I) iodide combined with potassium bromide and/or potassium iodide as component b) and N,N′-ethylenebisstearamide [CAS No. 110-30-5] as component c).

The present invention relates with very particular preference to compositions comprising as ingredients
a) PA6 or PA66 or a copolyamide of PA6 or PA66,
b) copper(I) iodide combined with potassium bromide and/or potassium iodide,
c) N,N′-ethylenebisstearamide, and
d) a long fiber reinforcement which comprises up to 90 wt % of fibers having a fiber diameter in the range from 5 to 25 μm, of which not less than 80% have a length of at least 5 mm, and which contains up to 10 wt % of at least one added-substance material.

The present invention relates with very particular preference to compositions comprising as ingredients
a) 15 to 89.79 wt % of PA6 or PA66 or a copolyamide of PA6 or PA66,
b) 0.01 to 2 wt % of copper(I) iodide combined with potassium bromide and/or potassium iodide,
c) 0.05 to 3 wt % of N,N′-ethylenebisstearamide,
d) 10 to 80 wt % of long fiber reinforcement which comprises up to 90 wt % of fibers having a fiber diameter in the range from 5 to 25 μm, of which not less than 80% of fibers have a length of at least 5 mm, and which contains up to 10 wt % of at least one added-substance material, and
e) 0.1 to 30 wt % of at least one further additive,
   wherein the sum total of all weight percentages always comes out as 100 wt %.

The present invention also relates with preference to compositions comprising as ingredients

### a) PA6,

b) at least one thermal stabilizer,
c) at least one ester wax, and also
d) a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material.

The present invention also relates with particular preference to compositions comprising as ingredients

### a) 15 to 89.79 wt % of PA6,

b) 0.01 to 2 wt % of at least one thermal stabilizer,
c) 0.05 to 3 wt % of at least one ester wax, and also
d) 10 to 80 wt % of a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material.

The present invention relates with preference to compositions comprising as ingredients

a) PA6, in particular at 15 to 89.78 wt %,
b) copper(I) iodide and potassium bromide, in particular at 0.01 to 2 wt %,
c) at least one ester wax, in particular at 0.05 to 3 wt %, and also
d) a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material, in particular at 10 to 80 wt %.

The present invention relates with preference to compositions comprising as ingredients

a) PA6, in particular at 15 to 89.78 wt %,
b) copper(I) iodide and potassium bromide, in particular at 0.01 to 2 wt %,
c) at least one amide wax, in particular at 0.05 to 3 wt %, and also
d) a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material, in particular at 10 to 80 wt %.

The present invention relates with preference to compositions comprising as ingredients

a) PA6, in particular at 15 to 89.78 wt %,
b) at least copper(I) iodide, in particular at 0.01 to 2 wt %,
c) N,N′-ethylenebisstearamide, in particular at 0.05 to 3 wt %, and also
d) a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material, in particular at 10 to 80 wt %.

The present invention relates with preference to compositions comprising as ingredients

a) PA6, in particular at 15 to 89.78 wt %,
b) copper(I) iodide and potassium bromide, in particular at 0.01 to 2 wt %,
c) N,N′-ethylenebisstearamide, in particular at 0.05 to 3 wt %, and also
d) a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material, in particular at 10 to 80 wt %.

The present invention also relates with preference to compositions comprising as ingredients

### a) PA6,

b) copper(I) iodide and potassium bromide,
c) N,N′-ethylenebisstearamide,
d) a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material, and
e) carbon black.

The present invention also relates with preference to compositions comprising as ingredients

### a) PA6,

b) copper(I) iodide and potassium bromide,
c) N,N′-ethylenebisstearamide,
d) a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material,
e) carbon black, and
f) talc.

The above-described method of the present invention is in its versions (I), (II) and (III) followed for example by an injection molding process wherein the composition of the present invention, while it is preferably in pellet form, is melted (plastified) in a heated cylindrical cavity and injected in the form of injection melt under pressure into a temperature regulated cavity. Once the melt has cooled (solidified), the injection molding is demolded. See: http://de.wikipedia.org/wiki/Spritzgie%C3%9Fen.

The various stages are

1st plastification/melting
2nd injection phase (charging procedure)
3rd hold pressure phase (to take account of thermal contraction during crystallization)
4th demolding.

An injection molding machine consists of a clamping unit, the injection unit, the drive and the control system. The clamping unit has fixed and movable platens for the mold, an end platen, and also tie bars and a drive for the movable mold platen (toggle assembly or hydraulic clamping unit).

An injection unit encompasses the electrically heatable cylinder, the screw drive (motor, gearbox) and the hydraulic system for displacing the screw and injection unit. The office of the injection unit consists in melting, metering and Injecting the powder or the pellets and applying hold pressure thereto (to take account of contraction). The issue of reverse flow of the melt within the screw (leakage flow) is resolved by nonreturn valves.

Within the injection mold, the inflowing melt is then separated out of the composition to be employed in the present invention and cooled, and the required article is thus manufactured. Two mold halves are always needed for this process. Various functional systems within the injection molding process are as follows:
runner system
shaping inserts
venting
machine mounting and uptake of force
demolding system and transmission of motion
temperature regulation

In contrast to the injection molding process, the extrusion process (see: http://de.wikipedia.org/wiki/Extrusion_(Verfahrenstechnik)) uses a continuously shaped strand of plastic comprising a composition according to the present invention in an extruder, the extruder being a machine for producing thermoplastic moldings. Various types of equipment are
single screw extruders and twin screw extruders and also their respective subgroups
conventional single screw extruders, conveying single screw extruders,
contrarotatory twin screw extruders and corotatory twin screw extruders.

Extrusion plants consist of extruder, die, downstream equipment and extrusion blow molds. Extrusion plants for producing profiles consist of extruder, profile die, calibrator, cooling section, caterpillar and roller takeoff, separation device and tilting chute.

The present invention accordingly also provides articles of manufacture, in particular long fiber reinforced articles of manufacture, obtainable by extrusion or injection molding of the pelletized compositions comprising as ingredients

a) PA6 or PA66 or a copolyamide of PA6 or PA66,
b) at least one thermal stabilizer, and
c) at least one amide wax and/or at least one ester wax, and also
d) a long fiber reinforcement which comprises not less than 90 wt % of fibers having a fiber diameter in the range from 5 to 25 μm, of which not less than 80% of fibers have a length of at least 5 mm, and which contains up to 10 wt % of at least one added-substance material.

### EXAMPLES

The components identified in table 1 were mixed in a twin screw extruder of the ZSK 26 type from Coperion Werner & Pfieiderer (Stuttgart, Germany) at a temperature of about 280° C., strand extruded into a water bath, cooled down to the point of pelletizability and pelletized. The pellet material was dried to constant weight at 70° C. in a vacuum drying cabinet. Pelletizability for the purposes of the present invention is to be understood as meaning that the extrudate can be severed by the pelletizer knife without stringiness.

TABLE 1
Composition of inventive examples and evaluation of emission
on extrusion with long glass fibers

| | Example 1 | Example 2 |
|---|---|---|
| polyamide 6 A | 99.25 | |
| polyamide 6 B | | 99.25 |
| N,N′-ethylenebisstearamide | 0.25 | 0.25 |
| copper(I) iodide | 0.06 | 0.06 |
| potassium bromide | 0.16 | 0.16 |
| carbon black | 0.25 | 0.25 |
| talc | 0.03 | 0.03 |
| evaluation of emissions | 1 | 1 |
| on extrusion with long | | |
| glass fibers [1-5] | | |

The compositions of inventive examples 1 and 2 were melted in a twin screw extruder and heated to a temperature of 280° C. Long glass fibers were then metered into the melt, the rate of addition being adjusted such that the proportion of long glass fibers including the added-substance materials in the form of binders, sizes or was 30 wt % based on the entire composition including long glass fibers. The thermoplastic melt was extruded through a wide slot die and the emissions at the die were visually assessed on a scale from 1 to 5, where 1 denotes very minimal observed emissions in the form of smoking decomposition products of the polyamide and 5 denotes very intensive and troublesome emissions. Only very minimal emissions were observed for the two examples in accordance with the present invention.

### Materials Used:

Polyamide 6 A, linear with an ISO 307 viscosity number—determined in a 0.5 wt % solution in 96 wt % sulfuric acid at 25° C.—of 145 ml/g.

Polyamide 6 B, linear with an ISO 307 viscosity number—determined in a 0.5 wt % solution in 96 wt % sulfuric acid at 25° C.—of 107 ml/g.

N,N′-Ethylenebisstearamide, Acrawax® C from Lonza Cologne GmbH, CAS No. 110-30-5

Copper(I) iodide, d99<70 μm, CAS No. 7681-65-4

Potassium bromide, d99<70 μm, CAS No. 7758-02-3

Talc CAS No. 14807-96-6

Carbon black CAS No. 1333-86-4

Long glass fiber with a nominal diameter of 16 μm, a size content of about 0.3%, a linear density of 2400 text and a length of about 8300 m, e.g., StarRov® LFT Plus PR 440 2400 871 from Johns Manville

1. A composition comprising:
a) PA6 or PA66 or a copolyamide of PA6 or PA66,
b) at least one thermal stabilizer,
c) at least one amide wax and/or at least one ester wax, and
d) a long fiber reinforcement which comprises:
not less than 90 wt % of fibers having a fiber diameter of 5 to 25 μm, of which not less than 80% of the fibers have a length of at least 5 mm, and
up to 10 wt % of at least one added-substance material.

2. The composition as claimed in claim 1, comprising:
a) 15 to 89.79 wt % of the PA6 or PA66 or copolyamide of PA6 or PA66,
b) 0.01 to 2 wt % of the at least one thermal stabilizer,
c) 0.05 to 3 wt % of the at least one amide wax and/or at least one ester wax, and
d) 10.1 to 80 wt % of the long fiber reinforcement,
wherein the sum total of all weight percentages is always 100 wt %.

3. The composition as claimed in claim 1, wherein the added-substance material comprises a material selected from the group consisting of binders, size and tying fibers.

4. The composition as claimed in claim 1, wherein the at least one thermal stabilizer b) comprises at least one component selected from the group consisting of copper compounds, sterically hindered phenols, phosphites, phosphates, hydroquinones, aromatic secondary amines, substituted resorcinols, salicylates, benzotriazoles benzophenones, and also variously substituted representatives of these components, and mixtures thereof.

5. The composition as claimed in claim 1, wherein the amide wax is at least one compound prepared via a condensation reaction of long-chain carboxylic acids with mono- or polyfunctional amines.

6. The composition as claimed in claim 1, wherein the ester wax is at least one compound prepared by a condensation reaction of one or more than one long-chain monofunctional aliphatic carboxylic acid with an alcohol.

7. The composition as claimed in claim 1, wherein the composition is in the form of: pellets at least 5 mm in length; intermediate products; continuous fiber reinforced semi-finished goods; and also articles of manufacture, moldings or component parts.

8. The composition as claimed in claim 7, wherein the composition is in the form of continuous fiber reinforced semi-finished goods, or articles of manufacture, or moldings, or component parts, and the long fibers in the continuous fiber reinforced semi-finished goods, articles of manufacture, moldings or component parts have a length of up to several meters.

9. The composition as claimed in claim 7, wherein the composition is in the form of pellets, and the long fibers in the individual pellets have a parallel alignment relative to the length of the individual pellets.

10. The composition as claimed in claim 1, wherein the long fiber reinforcement comprises long fiber selected from the group consisting of glass fibers, carbon fibers, natural fibers, polymeric fibers, steel fibers, mineral fibers, and mixtures thereof.

11. A method of producing the composition as claimed in claim 1, the method comprising:
(Ia) mixing and melting the components a), b) and c) in a first mixing tool at a temperature of 220 to 400° C. and at a pressure of 2 to 50 bar to produce a first melt containing components a), b) and c), and
one of:
I) (Ib) thereafter admixing component d) in the form of fibers to the melt in the first mixing tool to form a second melt containing components a) to d), and
(Ic) exporting the second melt from the first mixing tool and optionally subjected the second melt to further processing steps,
or
II) (IIb) thereafter transferring the first melt from the first mixing tool into a second mixing tool and adding component d) in the form of fibers and/or yarns to the first melt in the second mixing tool and impregnated the fibers and/or yarns with the melt to form a second melt containing components a) to d), and
(IIc) thereafter exporting the second melt from the second mixing tool via a mixing unit outlet and optionally subjected the second melt to further processing steps,
or
III) (IIIb) metering component d) in the form of fibers and/or yarns into the first mixing tool to form a second melt containing components a) to d), and
(IIIc) thereafter exporting the second melt from the first mixing tool via a mixing tool outlet and optionally subjected the second melt to further processing steps,
or
IV) (IVb) exporting the first melt out of the mixing tool via a mixing tool outlet, and via the mixing tool outlet, contacting the first melt with at least two plies of two-dimensional component d) to form a composite, and
(IVc) transferring the composite into a pressing tool and pressmolding the composite together to form an article of manufacturer.

12. The method as claimed in claim 11, wherein for (IVb) component d) comprises non-crimp fabrics, wovens, braids, weft-knitted fabrics produced by weft knitting with independently movable needles, stitched fabrics, nonwovens, fiber tows or rovings.

13. A method of reducing emissions in processes involving producing or utilizing polyamides, the method comprising mixing with the polyamide at least one thermal stabilizer, at least one ester wax and/or at least one amide wax, and long fiber reinforcements comprising up to 90 wt % of long fibers having a fiber diameter of 5-25 μm, of which not less than 80% have a fiber length of at least 5 mm, and the long fiber reinforcement contains up to 10 wt % of at least one added-substance material, to impregnate the fibers with a thermoplastic melt to form an impregnate comprising not less than 30 wt % of the polyamide, wherein the polyamide is PA6 or PA66 or a copolyamide of PA6 or PA66, and the emissions contain at least one of hydrocarbons, alcohols, aldehydes, organic acids and also monomers/decomposition products of the polyamides.

14. The method as claimed in claim 13, wherein the processes concern exporting, portioning or transferring the impregnate into further processing operations.

15. (canceled)

16. The composition as claimed in claim 1, comprising:
a) 15 to 89.79 wt % of the PA6 or PA66 or copolyamide of PA6 or PA66,
b) 0.01 to 2 wt % of copper(I) iodide combined with potassium bromide and/or potassium iodide,
c) 0.05 to 3 wt % of the at least one amide wax, and
d) 10.1 to 80 wt % of the long fiber reinforcement,
wherein the sum total of all weight percentages is always 100 wt %.

17. The composition as claimed in claim 1, comprising:
a) 15 to 89.79 wt % of the PA6 or PA66 or copolyamide of PA6 or PA6,
b) 0.01 to 2 wt % of copper(I) iodide combined with potassium bromide and/or potassium iodide,
c) 0.05 to 3 wt % of the at least one ester wax, and
d) 10.1 to 80 wt % of the long fiber reinforcement,
wherein the sum total of all weight percentages is always 100 wt %.

18. The composition as claimed in claim 1, comprising:
a) 15 to 89.79 wt % of the PA6,
b) 0.01 to 2 wt % of copper(I) iodide,
c) 0.05 to 3 wt % of N,N′-ethylenebisstearamide, and
d) 10.1 to 80 wt % of the long fiber reinforcement,
wherein the sum total of all weight percentages is always 100 wt %.

19. The composition as claimed in claim 18, further comprising 0.01 to 5 wt % of additional components comprising carbon black and talc, wherein an amount of at least one of components a), b), c) or d) is sufficiently reduced for the sum total of all weight percentages in the composition to always come out as 100 wt %.
